(19) United States
(12) Patent Application Publication
(10) Pub. No.: US 2005/0275778 A1
(43) Pub. Date: Dec. 15, 2005

(54) Transflective liquid crystal display

(75) Inventors: Hong-Sheng Cho, Miao-Li (TW); Chiu-Lien Yang, Miao-Li (TW); Ching-Hung Teng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/151,857

(22) Filed: Jun. 13, 2005

(30) Foreign Application Priority Data
Jun. 11, 2004 (CN) 2004100276592

(51) Int. Cl. G02F 1/1335

(52) U.S. Cl. 349/114

(57) ABSTRACT

A transflective liquid crystal display includes a lower polarizer (100) and an upper polarizer (101) facing each other, a liquid crystal cell (200) generally between the lower and upper polarizers, and a multilayer optical film (300) disposed between the lower polarizer and the liquid crystal cell. The multilayer optical film has a transmissive axis and a reflective axis. The light polarized parallel to the transmissive axis can transmit through the multilayer optical film, and light polarized parallel to the reflective axis can be reflected by the multilayer optical film. Thus, the TR-LCD, in transmissive mode, the polarized light that is from the backlight and passes the lower polarizer is completely useful. And in reflective mode, the polarized light from ambient and passing the upper polarizer is completely useful. That is, the efficiency of utilization of light is high.

### FIELD OF THE INVENTION

The present invention relates to transflective liquid crystal displays (TR-LCDs), and especially to a TR-LCD with polarizers.

### BACKGROUND

Due to the features of being thin and having low power consumption, liquid crystal displays have been used in a broad range of fields. Applications include office automation (OA) apparatuses such as word processors and personal computers, portable information apparatuses such as portable electronic schedulers, videocassette recorders (VCRs) provided with information panels, and mobile phones provided with liquid crystal monitors.

Unlike in a cathode ray tube (CRT) display or an electroluminescence (EL) display, the display screen of a liquid crystal display does not emit light itself. Instead, in a conventional transmission type liquid crystal display, an illuminator called a backlight is provided at a rear or one side of the liquid crystal display. A liquid crystal panel of the liquid crystal display controls the transmission of light received from the backlight, and light transmitting through the liquid crystal panel is used to provide images for display.

In the transmission type liquid crystal display, the backlight consumes 50% or more of the total power consumed by the liquid crystal display. That is, the backlight is a major contributor to power consumption.

In order to overcome the above problem, a reflection type liquid crystal display has been developed for portable information apparatuses which are often used outdoors or in places where artificial ambient light is available. The reflection type liquid crystal display is provided with a reflector formed on one of a pair of substrates, instead of having a backlight. Ambient light is reflected by the reflector to illuminate the display screen.

The reflection type liquid crystal display using the reflection of ambient light is disadvantageous, insofar as the visibility of the display screen is extremely low when the surrounding environment is dark. Conversely, the transmission type liquid crystal display is disadvantageous when the surrounding environment is bright. That is, the color reproduction is low and the display screen is not sufficiently clear because the display brightness is only slightly less than the brightness of the ambient light. In order to improve the display quality in a bright surrounding environment, the intensity of the light from the backlight needs to be increased. This increases the power consumption of the backlight and reduces the efficiency of the liquid crystal display. Moreover, when the liquid crystal display needs to be viewed at a position exposed to direct sunlight or direct artificial light, the display quality is generally lower. For example, when a display screen fixed in a car or a display screen of a personal computer receives direct sunlight or artificial light, surrounding images are reflected from the display screen. This makes it difficult to observe the images of the display screen itself.

In order to overcome the above problems, an apparatus which realizes both a transmissive mode display and a reflective mode display in a single liquid crystal display has been developed. The apparatus is called as a transflective liquid crystal display. Referring to FIG. 7, a conventional TR-LCD 1 includes an upper substrate 10 and a lower substrate 11 disposed opposite to each other and spaced apart a predetermined distance. A liquid crystal layer 30 having a multiplicity of liquid crystal molecules (not labeled) is disposed between the upper and lower substrates 10 and 11. A backlight module (not shown) is disposed under the lower substrate 11, for providing illumination for the TR-LCD 1.

An upper polarizer 20 is arranged on an outer surface of the upper substrate 10, and an upper alignment film 40 is arranged on an inner surface of the upper substrate 10. A lower polarizer 21 is arranged on an outer surface of the lower substrate 11. A transflector 50, pixel electrodes 13, counter electrodes 12, an isolating film 60, and a lower alignment film 41 are sequentially arranged on an inner surface of the lower substrate 11. Each of the upper and lower polarizers 20, 21 only allows one kind of polarized light to pass therethrough, such polarized light being polarized along an optical axis of respective upper or lower polarizer 20, 21. The optical axes of the upper and lower polarizers 20, 21 are perpendicular to each other.

When the TR-LCD 1 is in an on state, part of light emitted by the backlight transmits through the transflector 50 to be used in a transmissive mode, and part of ambient light is reflected by the transflector 50 to be used in a reflective mode. Thus the TR-LCD 1 provides a transflective display function.

FIG. 8 is an essential optical paths diagram of the TR-LCD 1 operating in the transmissive mode. Half of light emitted by the backlight can pass through the lower polarizer 21, whereby it becomes polarized light that is polarized along the optical axis of the lower polarizer 21. The polarized light then sequentially passes through the transflector 50, the liquid crystal layer 30, and the upper polarizer 20 to be used for display. However, in this process, some of the polarized light is reflected by the transflector 50 and is not utilized. Therefore, the efficiency of utilization of the light emitted by the backlight is low.

FIG. 9 is an essential optical paths diagram of the TR-LCD 1 operating in the reflective mode. Half of ambient light can pass through the upper polarizer 20, whereby it becomes polarized light that is polarized along the optical axis of the upper polarizer 20. The polarized light then passes through the liquid crystal layer 30. Only part of the polarized light is then reflected by the transflector 50. The reflected polarized light then sequentially passes through the liquid crystal layer 30 and the upper polarizer 20 to be used for display. In this process, a remainder of the polarized light that passes through the transflector 50 is not utilized. That is, the efficiency of utilization of the ambient light is low.

What is needed, therefore, is a TR-LCD with highly efficient utilization of light.

### SUMMARY

In an exemplary embodiment, a TR-LCD includes a lower polarizer and an upper polarizer facing each other, a liquid crystal cell generally between the lower and upper polarizers, and a multilayer optical film disposed between the lower polarizer and the liquid crystal cell. The multilayer optical film has a transmissive axis and a reflective axis, wherein light polarized parallel to the transmissive axis can transmit through the multilayer optical film, and light polarized parallel to the reflective axis can be reflected by the multilayer optical film.

The multilayer optical film comprises a plurality of first layers and second layers alternately stacked on each other, and defines an optical axis. The first and second layers have a same refractive index according to light polarized parallel to the optical axis, and the first layers have a refractive index different from that of the second layers according to light polarized perpendicular to the optical axis.

Thus, in transmissive mode, the polarized light that is emitted by the backlight and passes the lower polarizer is completely useful. And in reflective mode, the polarized light that is from ambient and passes the upper polarizer is completely useful. That is, the utilization efficiency of light is high.

Other advantages and novel features will become more apparent from the following detailed description when taken in conjunction with the accompanying drawings, in which:

### BRIEF DESCRIPTION OF THE DRAWINGS

FIG. 1 is a schematic, exploded, isometric view of a TR-LCD according to an exemplary embodiment of the present invention;

FIG. 2 is a schematic, enlarged, abbreviated view of a multilayer optical film of the TR-LCD of FIG. 1;

FIG. 3 is a side view of the TR-LCD of FIG. 1, showing essential optical paths when the TR-LCD operates in a transmissive mode;

FIG. 4 is a side view of the multilayer optical film of FIG. 2 together with a lower polarizer of the TR-LCD of FIG. 1, showing an essential optical path of light emitted by a backlight (not shown) when the TR-LCD operates in the transmissive mode;

FIG. 5 is similar to FIG. 5, but showing essential optical paths when the TR-LCD operates in a reflective mode;

FIG. 6 is a side view of the multilayer optical film of FIG. 2 together with an upper polarizer of the TR-LCD of FIG. 1, showing an essential optical path of ambient light when the multilayer TR-LCD operates in the reflective mode;

FIG. 7 is a schematic, side cross-sectional view of part of a conventional TR-LCD;

FIG. 8 is an essential optical paths diagram regarding particular components of the TR-LCD of FIG. 7, showing paths when the TR-LCD operates in a transmissive mode; and

FIG. 9 is similar to FIG. 8, but showing essential optical paths when the TR-LCD operates in a reflective mode.

### DETAILED DESCRIPTION OF PREFERRED EMBODIMENTS

Referring to FIG. 1, a TR-LCD 2 according to an exemplary embodiment of the present invention includes an upper polarizer 100, a lower polarizer 101 facing the upper polarizer 100, a liquid crystal cell 200 generally between the upper and lower polarizers 100 and 101, and a multilayer optical film 300 interposed between the liquid crystal cell 300 and the lower polarizer 101. A backlight module (not shown) is disposed under the lower polarizer 101, for illuminating the TR-LCD 2.

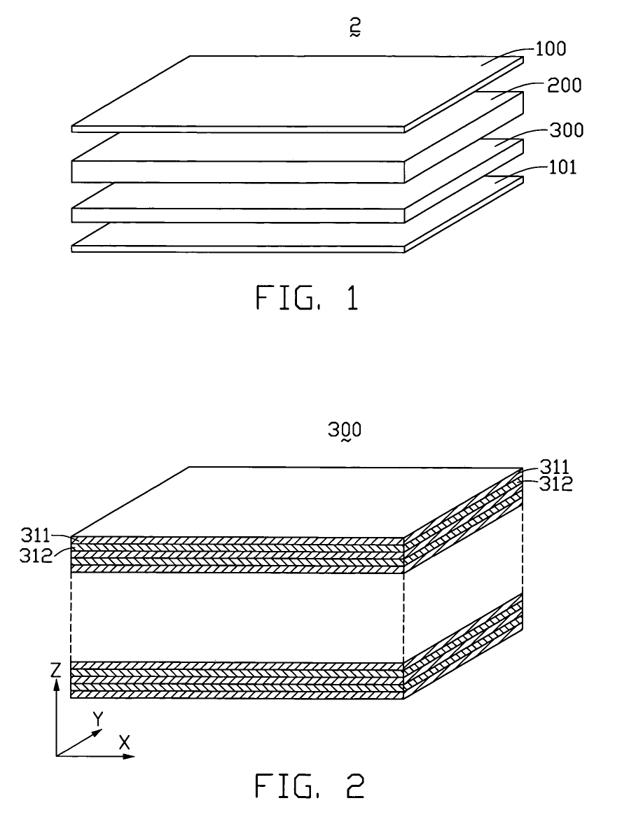

Also referring to FIG. 2, this is a schematic, side cross-sectional view of the multilayer optical film 300. The multilayer optical film 300 comprises a plurality of first layers 311 and second layers 312 alternately stacked on each other.

Each first layer 311 is made of Polyethylene Naphthalate, and each second layer 312 is made of an isomer of Polyethylene Naphthalate. Alternatively, materials of the layers 311, 312 can be select from any one or more of Polycarbonate, Polyethylene Terephthalate, Polymethyl Methacrylate, Polyethylene, and Cyclo Olefin Polymers.

The multilayer optical film 300 has a transmissive axis (defined as an X-direction) and a reflective axis (defined as a Y-direction). Light polarized parallel to the transmissive axis can transmit through the multilayer optical film 300, and light polarized parallel to the reflective axis can be reflected by the multilayer optical film 300. An optical axis of the lower polarizer 101 is parallel to the transmissive axis of the multilayer optical film 300. An optical axis of the upper polarizer 100 is parallel to the reflective axis of the multilayer optical film 300.

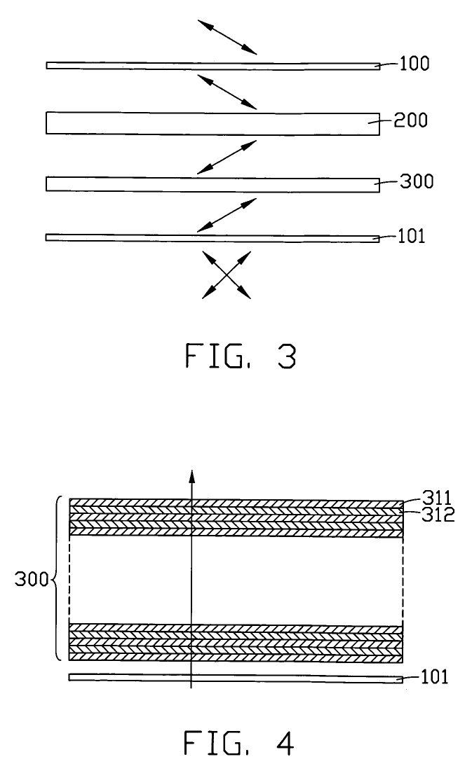

FIG. 3 is a side view of essential optical paths of the TR-LCD 2 when it operates in a transmissive mode. Half of light emitted by the backlight passes through the lower polarizer 101 and becomes polarized light that is polarized along the optical axis of the lower polarizer 101. Also referring to FIG. 4, the optical axis of the lower polarizer 101 is parallel to the transmissive axis of the multilayer optical film 300. Therefore, all of the polarized light transmitting from the lower polarizer 101 can transmit through the multilayer optical film 300, because the polarized direction of the polarized light is parallel to the transmissive axis of the multilayer optical film 300. The polarized light then transmits to the liquid crystal cell 200, and is twisted by the liquid crystal cell 200 to become polarized light that is polarized parallel to the optical axis of the upper polarizer 100. Such polarized light then transmits through the upper polarizer 100 to display images. The first and second layers 311 and 312 of the multilayer optical film 300 have a same refractive index according to light polarized parallel to the optical axis. In this embodiment, the refractive index of each layer 311, 312 according to light polarized parallel to the optical axis is 1.64.

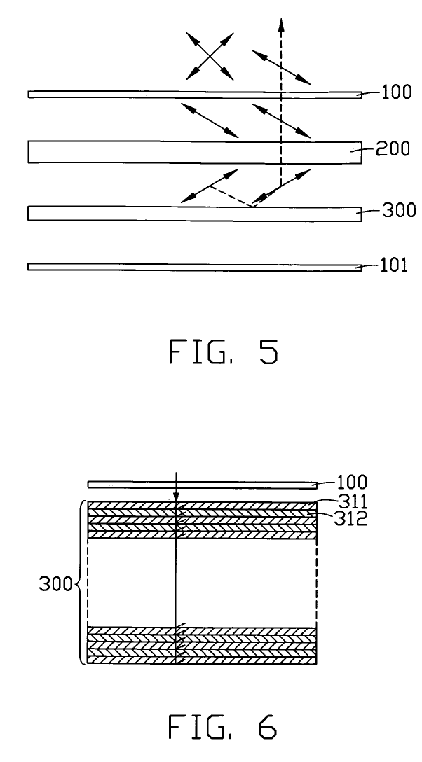

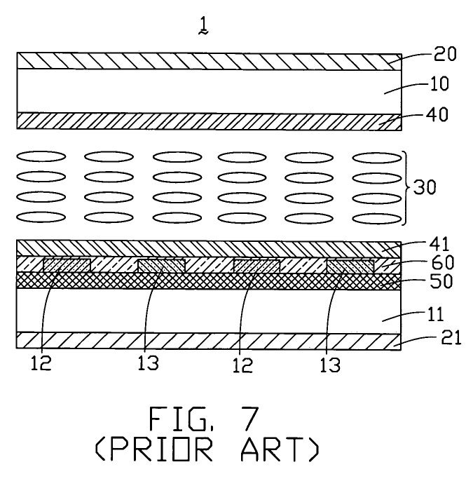

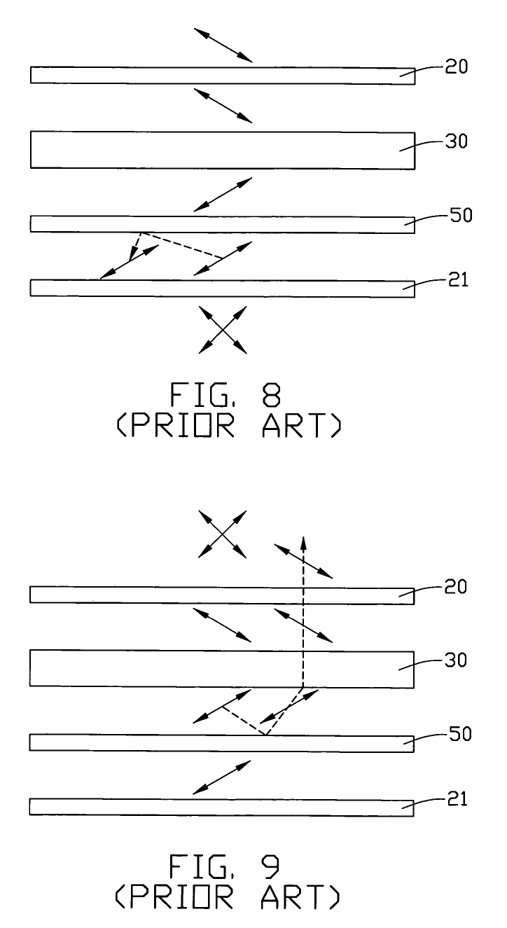

FIG. 5 is a side view of essential optical paths of the TR-LCD 2 when it operates in a reflective mode. Half of ambient-sourced light passes through the upper polarizer 100, and becomes polarized light that is polarized along the optical axis of the upper polarizer 100. The polarized light transmits to the liquid crystal cell 200, and is twisted by the liquid crystal cell 200 to become polarized light that is polarized parallel to the reflective axis of the multilayer optical film 300. Also referring to FIG. 6, the optical axis of the upper polarizer 100 is parallel to the reflective axis of the multilayer optical film 300. Therefore, all of the polarized light transmitting from the upper polarizer 100 can be reflected by the multilayer optical film 300, because the polarized direction of the polarized light is parallel to the reflective axis of the multilayer optical film 300. The polarized light then transmits to the liquid crystal cell 200 again, and is twisted by the liquid crystal cell 200 to become polarized light that is polarized parallel to the optical axis of the upper polarizer 100. Such polarized light then transmits through the upper polarizer 100 to display images. The first and second layers 311 and 312 of the multilayer optical film 300 have different refractive indexes according to light polarized perpendicular to the optical axis. Each first layer 311 has a higher refractive index according to light polarized perpendicular to the optical axis, while each second layer 312 has a lower refractive index according to light polarized perpendicular to the optical axis. An uppermost one of the first layers 311 is adjacent to the liquid crystal cell 200. In this embodiment, the refractive index of the first layers 311 according to light polarized perpendicular to the optical axis is 1.88, and the refractive index of the second layers 312 according light polarized perpendicular to the optical axis is 1.64.

The liquid crystal cell 200 can be any of various types of liquid crystal cell known in the art, such as a Twisted Nematic (TN) type, a Super Twisted Nematic (STN) type, an In-Plane Switching (IPS) type, a Vertical Alignment (VA) type, a Homogeneous Alignment type, or an Optical Compensated Birefringence (OCB) type.

In summary, when the above-described TR-LCD operates in the transmissive mode, backlight that passes through the lower polarizer becomes polarized light, and this polarized light is completely utilized. When the TR-LCD operates in the reflective mode, ambient light that passes through the upper polarizer becomes polarized light, and this polarized light is completely utilized. Overall, the efficiency of utilization of light is high.

It is to be understood, however, that even though numerous characteristics and advantages of the present embodiments have been set forth in the foregoing description, together with details of the structures and functions of the embodiments, the disclosure is illustrative only, and changes may be made in detail to the full extent indicated by the broad general meaning of the terms in which the appended claims are expressed.

1. A transflective liquid crystal display, comprising:
a lower polarizer and an upper polarizer facing each other;
a liquid crystal cell generally between the lower and upper polarizers; and
a multilayer optical film disposed between the lower polarizer and the liquid crystal cell, the multilayer optical film having a transmissive axis and a reflective axis;
wherein light polarized parallel to the transmissive axis can transmit through the multilayer optical film, and light polarized parallel to the reflective axis can be reflected by the multilayer optical film.

2. The transflective liquid crystal display as claimed in claim 1, wherein an optical axis of the lower polarizer is parallel to the transmissive axis of the multilayer optical film.

3. The transflective liquid crystal display as claimed in claim 2, wherein an optical axis of the upper polarizer is parallel to the reflective axis of the multilayer optical film.

4. The transflective liquid crystal display as claimed in claim 1, wherein the multilayer optical film comprises a plurality of first layers and second layers alternately stacked on each other.

5. The transflective liquid crystal display as claimed in claim 4, wherein the first layers comprise Polyethylene Naphthalate, and the second layers comprise an isomer of Polyethylene Naphthalate.

6. The transflective liquid crystal display as claimed in claim 4, wherein one or more materials of the first and/or second layers is selected from the group consisting of Polycarbonate, Polyethylene Terephthalate, Polymethyl Methacrylate, Polyethylene, and Cyclo Olefin Polymer.

7. A transflective liquid crystal display, comprising:
a lower polarizer and an upper polarizer facing each other;
a liquid crystal cell generally between the lower and upper polarizers; and
a multilayer optical film disposed between the lower polarizer and the liquid crystal cell, the multilayer optical film comprising a plurality of first layers and second layers alternately stacked on each other, and defining an optical axis;
wherein the first and second layers have a same refractive index according to light polarized parallel to the optical axis, and the first layers have a refractive index different from that of the second layers according to light polarized perpendicular to the optical axis.

8. The transflective liquid crystal display as claimed in claim 7, wherein the refractive index of the first and second layers according to light polarized parallel to the optical axis is approximately 1.64.

9. The transflective liquid crystal display as claimed in claim 7, wherein the refractive index of the first layers according to light polarized perpendicular to the optical axis is approximately 1.88, and the refractive index of the second layers according to light polarized perpendicular to the optical axis is approximately 1.64.

10. The transflective liquid crystal display as claimed in claim 7, wherein the first layers have a refractive index higher than that of the second layers according to light polarized perpendicular to the optical axis, and one of the first layers is adjacent to the liquid crystal cell.

11. A transflective liquid crystal display, comprising:
a lower polarizer and an upper polarizer facing each other;
a liquid crystal cell generally between the lower and upper polarizers; and
a multilayer optical film disposed between the lower polarizer and the liquid crystal cell, the multilayer optical film having a transmissive axis and a reflective axis;
wherein the transmissive axis is parallel to an optical axis of the lower polarizer while the reflective axis is parallel to an optical axis of the upper polarizer.
